(19) United States
(12) Patent Application Publication
(10) Pub. No.: US 2026/0053703 A1
(43) Pub. Date: Feb. 26, 2026

(54) HOT AND COLD IMMERSION TUB AND TEMPERATURE CONTROL SYSTEM THEREFOR

(71) Applicant: PowerTub LLC, West Hollywood, CA (US)

(72) Inventors: Garret Camp, San Francisco, CA (US); Robert Carlson, Boise, ID (US); Angelo Sotiracopoulos, Los Angeles, CA (US); Benjamin Wald, Chevy Chase, MD (US)

(73) Assignee: PowerTub LLC, West Hollywood, CA (US)

(21) Appl. No.: 18/810,245

(22) Filed: Aug. 20, 2024

(51) Int. Cl. A61H 33/00

(52) U.S. Cl. CPC A61H 33/0095; A61H 33/005; A61H 33/6005; A61H 33/6047; A61H 33/6068; A61H 2201/0207; A61H 2201/0214; A61H 2201/0242; A61H 2201/0264; A61H 2201/1246; A61H 2201/501; A61H 2201/5082

(57) ABSTRACT

A contrast therapy cold plunge tub is supplied by hot and cold tempered water reservoirs, and a series of pumps and valves that allow multiple temperature change cycles that rapidly vary the water temperature within the tub between ambient, hot and cold temperatures. One example operates in a continuous immersion mode, where the water temperature is rapidly changed while the tub remains full. A further example operates in a drain and fill mode, where the tub including water at a first temperature is rapidly drained and then refilled with water at a second, different temperature. The present technology further includes a session control software application allowing users to control their user experience.

### BACKGROUND

The use of cold plunge tubs for therapeutic purposes has a long history, dating back to ancient cultures where immersion in cold water was used to promote healing, reduce inflammation, and improve overall health. Modern cold plunge tubs have evolved to include contrast therapy, a method that alternates between hot and cold water to stimulate blood flow, reduce muscle soreness, and accelerate recovery. Traditional methods for contrast therapy include separate hot and cold tubs, or cycling hot and cold water in a single tub. One drawback to this later technique is that a significant amount of time is required to achieve the desired changes in water temperature. Slow transitions from hot to cold water, and vice-versa, lessen the therapeutic value of such tubs.

### DESCRIPTION OF THE DRAWINGS

FIGS. 1 and 2 are perspective views of a system for providing contrast therapy sessions in a tub according to embodiments of the present invention.

FIG. 3 is a block diagram of a system for providing contrast therapy sessions in a tub according to an embodiment of the present technology.

FIG. 4 is a graph of tub temperature versus volume of water pumped in to the tub from a cold tempered reservoir according to an embodiment of the present technology.

FIG. 5 is a block diagram of a system for providing contrast therapy sessions in a tub according to an alternative embodiment of the present technology.

FIG. 6 is a cross-sectional perspective view of a tub according to an embodiment of the present technology.

FIG. 7 is a cross-sectional end view of a tub according to an embodiment of the present technology.

FIG. 8 is a cross-sectional end view of a tub according to an alternative embodiment of the present technology.

FIG. 9 is a graph of a sample contrast therapy session according to an embodiment of the present technology.

FIG. 10 is a perspective view of an integrated system for providing contrast therapy sessions in a tub according to alternative embodiments of the present invention.

FIG. 11 is a perspective view of an in-home system for providing contrast therapy sessions in a tub according to alternative embodiments of the present invention.

FIG. 12 is a cross-sectional perspective view of the tub shown in FIG. 11.

FIG. 13 is a sample graphical user interface (GUI) from a session control software application running on a smart device for defining cycles of a contrast therapy session and providing feedback from the system according to embodiments of the present technology.

FIG. 14 shows another sample of a smart device for controlling a contrast therapy session and providing feedback from the system according to further embodiments of the present technology.

FIG. 15 is a schematic block diagram of an ecosystem of smart devices used to collect data and select an optimized contrast therapy session recipe for a user.

FIG. 16 is a schematic block diagram of a computing environment according to embodiments of the present technology.

### DETAILED DESCRIPTION

The present technology will now be described with reference to the figures, which in embodiments, relate to a contrast therapy cold plunge tub capable of rapid temperature changes, and a temperature control system therefor. The tub is supplied by hot and cold tempered water reservoirs, and a series of pumps and valves that allow multiple temperature change cycles that rapidly vary the water temperature within the tub between ambient, hot and cold temperatures. One embodiment operates in a continuous immersion mode, where the water temperature is rapidly changed while the tub remains full. A further embodiment operates in a drain and fill mode, where the tub including water at a first temperature is rapidly drained and then refilled with water at a second, different temperature.

The system may work with a single media. That is, the system may have a single water supply that gets moved between the hot and cold tempered reservoirs and the tub. In a further embodiment, the system may work with a primary and secondary media. In this example, the water in the tub is the primary media, and the secondary, heating and cooling media may be stored in the hot and cold tempered reservoirs. The primary and secondary media in this embodiment do not mix. Rather, heat is transferred to/from the primary media by passing the primary media through a heat exchanger. The heat exchanger is either heated or cooled by receipt of the secondary media from either the hot or cold tempered reservoirs, respectively.

The present technology further includes a control system for implementing predefined and/or user-defined contrast therapy sessions, including one or more dwell times at cold temperatures interspersed with one or more dwell times at higher, or recovery, temperatures. In the user-defined option, the user is able to set the desired start and end temperatures, the temperatures at the cold and recovery temperature cycles, and dwell times at those temperatures. The control system may be implemented from an application running on a smartphone, tablet or other smart computing device. Alternatively, the control system may be implemented from a dedicated controller.

As explained below, the control system for the present technology may be tied into a larger ecosystem of connected smart devices. These devices may measure various physiological traits of a user, or receive input from the user, to determine a current physical and/or mental condition of the user. This information may be used by the control system to devise or recommend a particular contrast therapy session specifically tailored to the user's physical and/or mental condition.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

The terms “top” and “bottom,” “upper” and “lower” and “vertical” and “horizontal,” and forms thereof, as may be used herein are by way of example and illustrative purposes only, and are not meant to limit the description of the technology inasmuch as the referenced item can be exchanged in position and orientation. Also, as used herein, the terms “substantially” and/or “about” mean that the specified dimension or parameter may be varied within an acceptable manufacturing tolerance for a given application. In one embodiment, the acceptable manufacturing tolerance is ±0.15 mm, or alternatively, ±2.5% of a given dimension.

For purposes of this disclosure, a connection may be a direct connection or an indirect connection (e.g., via one or more other parts). In some cases, when a first element is referred to as being connected, affixed, mounted or coupled to a second element, the first and second elements may be directly connected, affixed, mounted or coupled to each other or indirectly connected, affixed, mounted or coupled to each other. When a first element is referred to as being directly connected, affixed, mounted or coupled to a second element, then there are no intervening elements between the first and second elements (other than possibly an adhesive or melted metal used to connect, affix, mount or couple the first and second elements).

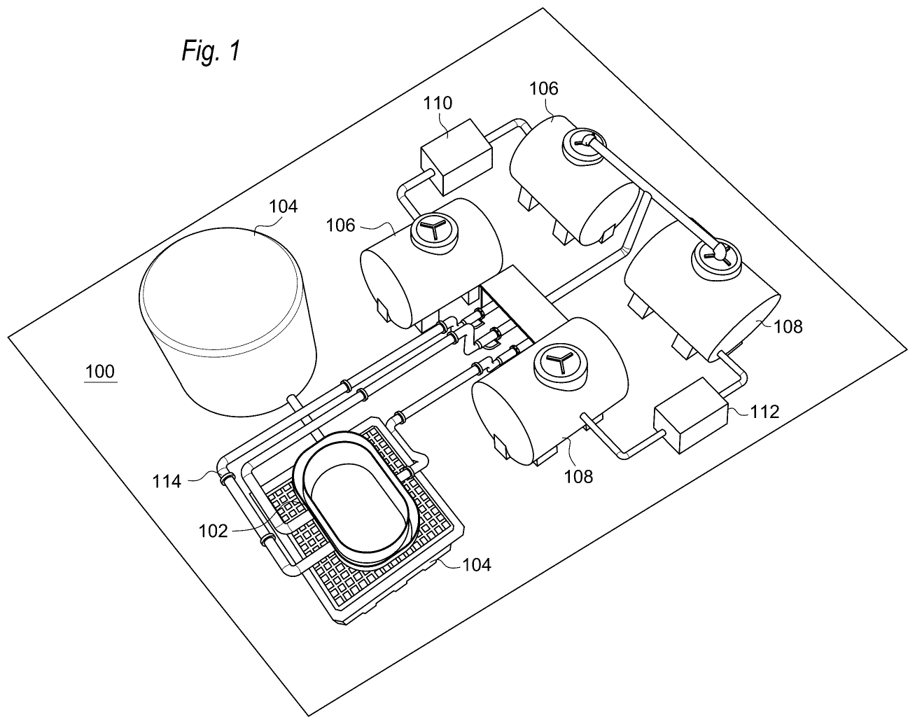

Embodiments of the present technology will now be explained with reference to the figures which show a contrast therapy system 100 including a tub 102, a catch reservoir 104 for storing water overflowed from tub 102 and hot and cold tempered reservoirs 106, 108 for supplying water at a tempered, or controlled, temperature to tub 102 as explained below. FIG. 1 shows a view of the system 100, located for example in the yard of a user. FIG. 2 shows a similar view with the tub 102 on a deck 105, visually and/or aurally segregated from the other components of the system.

The tub 102 may be constructed from metal, such as for example stainless steel, but other metals and materials are possible, including for example galvanized steel, copper, aluminum, high-strength plastic, fiberglass, or composite materials. The tub 102 may have rounded ends to enhance user comfort and safety by eliminating sharp edges. However, the tub 102 may have alternative configurations, including for example square, rectangular, or circular shapes. In embodiments, the tub may be configured to hold between 60 to 130 gallons of water, but this capacity may vary outside of this range in further embodiments. The tub 102 may include a large, elongated drain at its base as explained below.

Water drained or otherwise evacuated from the tub 102 may be captured in one or more catch reservoirs 104. In one example, a catch reservoir 104 may surround the tub 102. In a further example, a catch reservoir may be spaced from the tub, and connected to the tub by pipes. FIGS. 1 and 2 show a redundant system including a first catch reservoir 104 surrounding the tub 102, and a second catch reservoir 104 remote from the tub 102 and connected by pipes to the tub 102 or first catch reservoir 104. The decision of whether to use a single catch reservoir (either surrounding the tub or remote from the tub) or multiple catch reservoirs may be based in part on reservoir capacity and space considerations.

As explained hereinafter, water evacuated from the tub and captured in the one or more catch reservoirs 104 is blended water from both the hot and cold tempered reservoirs 106, 108. This blended temperature water is stored in the one or more catch reservoirs and is not reused during a session. In particular, to be reused, this blended temperature water would have to be either heated to the temperature of the hot tempered reservoir 106, or chilled to the temperature of the cold tempered reservoir 108. Instead, the system stores sufficient supplies of hot and cold tempered water in reservoirs 106, 108 as explained below, and water captured in the one or more catch reservoirs remains there until after a user session in tub 102 is completed. As such, the one or more catch reservoirs may be configured to hold all of the water evacuated from the tub 102 during all temperature change cycles in a session. In one example, the one or more catch reservoirs may be configured to hold 2100 gallons of water, though it may be more or less than that in further embodiments. Once a session is completed, the water from the one or more catch reservoirs 104 is pumped from the catch reservoir(s) to the hot and/or cold tempered reservoirs where the water is then heated and/or cooled over time in the respective reservoirs 106, 108 to the set reservoir temperatures for reuse.

Hot tempered water is stored in one or more hot water reservoirs 106 and cold tempered water is stored in one or more cold water reservoirs 108. FIGS. 1-3 each show two hot water and two cold water reservoirs 106, 108, but there may be more or less of each in further embodiments, depending in part on reservoir capacity and space considerations. In one embodiment, the one or more hot tempered reservoirs 106 may hold a total of 1,100 gallons, and the one or more cold tempered reservoirs 108 may hold a total of 1,100 gallons. However, it is understood that the total amount of water in the hot and/or cold tempered reservoirs may be above or below this in further embodiments. Where there are multiple hot tempered reservoirs 106, they may operate independently of each other, or they may be connected by pipes so that water can flow freely between them. The same is true of the cold tempered reservoirs 108.

The one or more hot tempered reservoirs 106 are maintained at a set temperature at or above the highest target temperature of the water in tub 102. It is advantageous to maintain the set temperature to be higher than the highest target recovery temperature within tub 102, as this will reduce any transition time to achieve the recovery target temperature in the tub as explained below. However, in embodiments it is also advantageous not to maintain the set temperature above a temperature that could burn a user of the tub when the hot water from the one or more reservoirs 106 is pumped into the tub. It also takes more energy to maintain a store of higher temperature water. In embodiments, the set temperature within the one or more hot tempered reservoirs may be selected by a user and may be between 104° F. and 120° F., though the set temperature of the hot tempered water may be higher or lower than that in further embodiments. As explained below, there are embodiments where the water from the hot tempered reservoir is not directly introduced into the tub, or is mixed with colder water before introduction into the tub. In such embodiments, the hot tempered reservoir may maintain temperatures of the media higher than 120° F.

The system 100 further includes one or more water heaters 110 coupled to the one or more hot tempered reservoirs 106 to heat and maintain the water in those reservoirs at the desired set temperature. As noted above, at the completion of a cycle, blended temperature water from the one or more catch reservoirs 104 may be transferred back to the one or more hot tempered reservoirs. At that point, the heater 110 is used to heat the blended temperature water back up to the selected set temperature within the one or more reservoirs 106.

The one or more cold tempered reservoirs 108 are maintained at a set temperature at or below the lowest target temperature of the water in tub 102. It is advantageous to maintain the set temperature to be lower than the lowest target temperature within tub 102, as this will reduce any transition time to achieve the low target temperature in the tub as explained below. However, it takes more energy to maintain a store of lower temperature water. In embodiments, the set temperature within the one or more cold tempered reservoirs may be selected by a user and may be between 32° F. and 45° F., though the set temperature of the cold tempered water may be higher or lower than that in further embodiments. As explained below, there are embodiments where the water from the cold tempered reservoir is not directly introduced into the tub, or is mixed with hotter water before introduction into the tub. In such embodiments, the cold tempered reservoir may maintain temperatures of the media lower than 32° F.

The system 100 further includes one or more water chillers 112 coupled to the one or more cold tempered reservoirs 108 to chill and maintain the water in those reservoirs at the desired set temperature. At the completion of a cycle, blended temperature water from the one or more catch reservoirs 104 may be transferred back to the one or more cold tempered reservoirs. At that point, the chiller 112 is used to cool the blended temperature water back down to the selected set temperature within the one or more reservoirs 108.

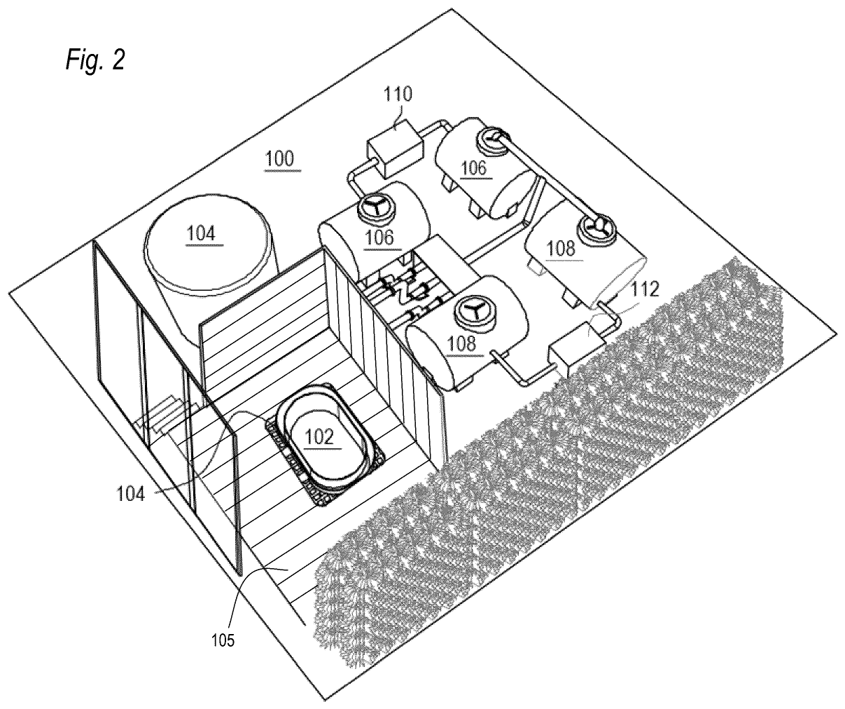

A series of pipes 114 and pumps 116 are used to transfer water from the reservoirs 106, 108 into and out of tub 102 as will now be explained with reference to FIG. 3. The pipes 114 may be PVC (Polyvinyl Chloride), CPVC (Chlorinated Polyvinyl Chloride) or some other polymer. The pipes 114 may alternatively be formed of a metal such as for example stainless steel. The diameters of pipes 114 may vary between 2 to 4 inches, the pipes 114 may have diameters outside of that range in further embodiments. Different pipes in the system may have different diameters. The pumps 116 may for example be centrifugal pumps, or positive displacement pumps, placed at junctions within pipes 114. In further embodiments, the pumps 116 can be submersible pumps positioned in the one or more reservoirs 104, 106 and 108. The number of each type of pump shown in FIG. 3 is by way of example only and may vary in further embodiments.

Upon initiation of a new cold water cycle (water temperature lowered from T₁ to T₂), a control system 120 (explained below) triggers one or more cold water pumps 116c connected to pipes 114 extending between the one or more cold tempered reservoirs 108 and the tub 102. Conversely, upon initiation of a new hot water (or recovery) cycle, the control system 120 triggers one or more hot water pumps 116h that are connected to pipes 114 extending between the one or more hot tempered reservoirs 106 and the tub 102. Flow valves (not shown) may be provided within the pipes 114 to ensure unidirectional flow though the pipes 114.

As noted, the present technology may implement one of two different modes of operation when changing the water temperature in the tub 102—continuous immersion, and drain and fill. In the continuous immersion mode, as water at the new temperature is being pumped into the tub 102, water inside the tub 102 is being drained or otherwise evacuated. In one example, water may be drained from the tub 102 using one or more drain pumps 116d, which pump water from the tub 102 to the one or more catch reservoirs 104. In a further embodiment, water at the new temperature is pumped into the tub and a mixture of the existing water and new water overflows the top sides of the tub. This process of the water at the current temperature T₁ being pumped out (or overflowing the sides), and new temperature water at T₂ being pumped in, continues until a temperature sensor in the tub indicates that the target temperature Tₜ for the new cycle has been achieved, at which point the pumps are shut off.

The time and volume of water it takes to change the temperature of the tub from T₁ to Tₜ depends on a variety of factors. These factors include:
the volumetric flow rates of the pumps;
the degree of mixing of the water at T₁ and T₂;
the overall volume of water in the tub (factoring in water displaced by any users in the tub);
in the event of a temperature increase, how far above the target temperature Tₜ is the inflowing water at T₂ from the hot tempered reservoir;
in the event of a temperature decrease, how far below the target temperature Tₜ is the inflowing water at T₂ from the cold tempered reservoir;
in the event of a temperature increase, how far below the target temperature Tₜ is the current water at temperature T₁;
in the event of a temperature decrease, how far above the target temperature Tₜ is the current water at temperature T₁.

As for volumetric flow rates, in one example, the pumps 116 (including the hot water pump(s) 116h, the cold water pump(s) 116c and the drain pump(s) 116d) may pump water at 200 gallons per minute, though the flow rate of one or more of these pumps may be greater or lesser than that in further embodiments.

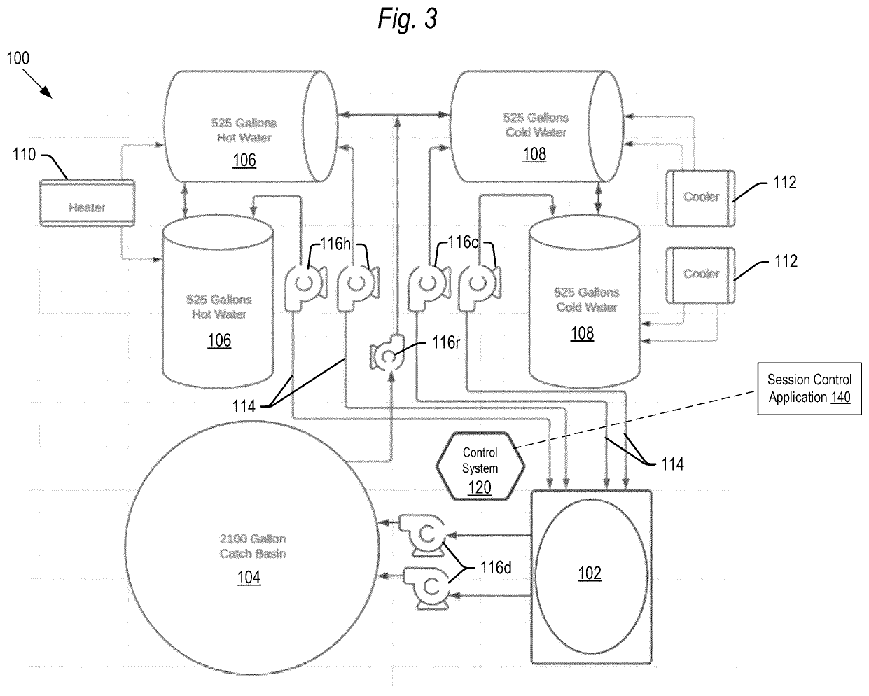

FIG. 4 shows a graph 122 of actual experimental data of one example where the water in a 150 gallon tub 102 with two people in it is at an initial (current) temperature T₁ of 90.0° F. The contrast therapy session running by the control system 120 signals that the temperature of the tub 102 is to cycle to a target temperature Tₜ of 50.0° F. The control system activates pumps 116c to pump cold water from cold tempered reservoir 108 into the tub, which temperature (T₂) in this example is 39° F. FIG. 4 is a graph plotting the data shown in Table 1 below of the change in temperature versus the inflow of cold tempered water at temperature T₂.

TABLE 1
Gallons

| T2 Added | Actual T | Target T |
|---|---|---|
| 0 | 90.0 | 50 |
| 1 | 89.6 | 50 |
| 2 | 89.2 | 50 |
| 3 | 88.8 | 50 |
| 4 | 88.4 | 50 |
| 5 | 88.1 | 50 |
| 6 | 87.7 | 50 |
| 7 | 87.3 | 50 |
| 8 | 86.9 | 50 |
| 9 | 86.6 | 50 |
| 10 | 86.2 | 50 |
| 11 | 85.8 | 50 |
| 12 | 85.5 | 50 |
| 13 | 85.1 | 50 |
| 14 | 84.8 | 50 |
| 15 | 84.4 | 50 |
| 16 | 84.1 | 50 |
| 17 | 83.7 | 50 |
| 18 | 83.4 | 50 |
| 19 | 83.0 | 50 |
| 20 | 82.7 | 50 |
| 21 | 82.4 | 50 |
| 22 | 82.0 | 50 |
| 23 | 81.7 | 50 |
| 24 | 81.4 | 50 |
| 25 | 81.0 | 50 |
| 26 | 80.7 | 50 |
| 27 | 80.4 | 50 |
| 28 | 80.1 | 50 |
| 29 | 79.8 | 50 |
| 30 | 79.5 | 50 |
| 31 | 79.1 | 50 |
| 32 | 78.8 | 50 |
| 33 | 78.5 | 50 |
| 34 | 78.2 | 50 |
| 35 | 77.9 | 50 |
| 36 | 77.6 | 50 |
| 37 | 77.3 | 50 |
| 38 | 77.0 | 50 |
| 39 | 76.7 | 50 |
| 40 | 76.4 | 50 |
| 41 | 76.2 | 50 |
| 42 | 75.9 | 50 |
| 43 | 75.6 | 50 |
| 44 | 75.3 | 50 |
| 45 | 75.0 | 50 |
| 46 | 74.8 | 50 |
| 47 | 74.5 | 50 |
| 48 | 74.2 | 50 |
| 49 | 73.9 | 50 |
| 50 | 73.7 | 50 |
| 51 | 73.4 | 50 |
| 52 | 73.1 | 50 |
| 53 | 72.9 | 50 |
| 54 | 72.6 | 50 |
| 55 | 72.4 | 50 |
| 56 | 72.1 | 50 |
| 57 | 71.8 | 50 |
| 58 | 71.6 | 50 |
| 59 | 71.3 | 50 |
| 60 | 71.1 | 50 |
| 61 | 70.8 | 50 |
| 62 | 70.6 | 50 |
| 63 | 70.4 | 50 |
| 64 | 70.1 | 50 |
| 65 | 69.9 | 50 |
| 66 | 69.6 | 50 |
| 67 | 69.4 | 50 |
| 68 | 69.2 | 50 |
| 69 | 68.9 | 50 |
| 70 | 68.7 | 50 |
| 71 | 68.5 | 50 |
| 72 | 68.2 | 50 |
| 73 | 68.0 | 50 |
| 74 | 67.8 | 50 |
| 75 | 67.6 | 50 |
| 76 | 67.4 | 50 |
| 77 | 67.1 | 50 |
| 78 | 66.9 | 50 |
| 79 | 66.7 | 50 |
| 80 | 66.5 | 50 |
| 81 | 66.3 | 50 |
| 82 | 66.1 | 50 |
| 83 | 65.9 | 50 |
| 84 | 65.7 | 50 |
| 85 | 65.5 | 50 |
| 86 | 65.3 | 50 |
| 87 | 65.0 | 50 |
| 88 | 64.8 | 50 |
| 89 | 64.7 | 50 |
| 90 | 64.5 | 50 |
| 91 | 64.3 | 50 |
| 92 | 64.1 | 50 |
| 93 | 63.9 | 50 |
| 94 | 63.7 | 50 |
| 95 | 63.5 | 50 |
| 96 | 63.3 | 50 |
| 97 | 63.1 | 50 |
| 98 | 62.9 | 50 |
| 99 | 62.7 | 50 |
| 100 | 62.6 | 50 |
| 101 | 62.4 | 50 |
| 102 | 62.2 | 50 |
| 103 | 62.0 | 50 |
| 104 | 61.8 | 50 |
| 105 | 61.7 | 50 |
| 106 | 61.5 | 50 |
| 107 | 61.3 | 50 |
| 108 | 61.2 | 50 |
| 109 | 61.0 | 50 |
| 110 | 60.8 | 50 |
| 111 | 60.6 | 50 |
| 112 | 60.5 | 50 |
| 113 | 60.3 | 50 |
| 114 | 60.1 | 50 |
| 115 | 60.0 | 50 |
| 116 | 59.8 | 50 |
| 117 | 59.7 | 50 |
| 118 | 59.5 | 50 |
| 119 | 59.3 | 50 |
| 120 | 59.2 | 50 |
| 121 | 59.0 | 50 |
| 122 | 58.9 | 50 |
| 123 | 58.7 | 50 |
| 124 | 58.6 | 50 |
| 125 | 58.4 | 50 |
| 126 | 58.3 | 50 |
| 127 | 58.1 | 50 |
| 128 | 58.0 | 50 |
| 129 | 57.8 | 50 |
| 130 | 57.7 | 50 |
| 131 | 57.5 | 50 |
| 132 | 57.4 | 50 |
| 133 | 57.3 | 50 |
| 134 | 57.1 | 50 |
| 135 | 57.0 | 50 |
| 136 | 56.8 | 50 |
| 137 | 56.7 | 50 |
| 138 | 56.6 | 50 |
| 139 | 56.4 | 50 |
| 140 | 56.3 | 50 |
| 141 | 56.2 | 50 |
| 142 | 56.0 | 50 |
| 143 | 55.9 | 50 |
| 144 | 55.8 | 50 |
| 145 | 55.6 | 50 |
| 146 | 55.5 | 50 |
| 147 | 55.4 | 50 |
| 148 | 55.3 | 50 |
| 149 | 55.1 | 50 |
| 150 | 55.0 | 50 |
| 151 | 54.9 | 50 |
| 152 | 54.8 | 50 |
| 153 | 54.6 | 50 |
| 154 | 54.5 | 50 |
| 155 | 54.4 | 50 |
| 156 | 54.3 | 50 |
| 157 | 54.2 | 50 |
| 158 | 54.1 | 50 |
| 159 | 53.9 | 50 |
| 160 | 53.8 | 50 |
| 161 | 53.7 | 50 |
| 162 | 53.6 | 50 |
| 163 | 53.5 | 50 |
| 164 | 53.4 | 50 |
| 165 | 53.3 | 50 |
| 166 | 53.2 | 50 |
| 167 | 53.0 | 50 |
| 168 | 52.9 | 50 |
| 169 | 52.8 | 50 |
| 170 | 52.7 | 50 |
| 171 | 52.6 | 50 |
| 172 | 52.5 | 50 |
| 173 | 52.4 | 50 |
| 174 | 52.3 | 50 |
| 175 | 52.2 | 50 |
| 176 | 52.1 | 50 |
| 177 | 52.0 | 50 |
| 178 | 51.9 | 50 |
| 179 | 51.8 | 50 |
| 180 | 51.7 | 50 |
| 181 | 51.6 | 50 |
| 182 | 51.5 | 50 |
| 183 | 51.4 | 50 |
| 184 | 51.3 | 50 |
| 185 | 51.2 | 50 |
| 186 | 51.1 | 50 |
| 187 | 51.0 | 50 |
| 188 | 50.9 | 50 |
| 189 | 50.9 | 50 |
| 190 | 50.8 | 50 |
| 191 | 50.7 | 50 |
| 192 | 50.6 | 50 |
| 193 | 50.5 | 50 |
| 194 | 50.4 | 50 |
| 195 | 50.3 | 50 |
| 196 | 50.2 | 50 |
| 197 | 50.1 | 50 |
| 198 | 50.1 | 50 |
| 199 | 50.0 | 50 |
| 200 | 49.9 | 50 |

As seen from the data of Table 1 and the graph of FIG. 4, as gallons of the cold water from the cold tempered reservoir 106 are pumped into the tub 102, the temperature of the water decreases. The tub reaches its target temperature Tₜ of 50° F. after 199 gallons of T₂ water have been pumped in. Once the temperature sensor in the tub indicates that the target temperature has been achieved, the pumps 116 are turned off. In one example, it may take 40 seconds to transition from the initial temperature T₁ of 90° F. to the target temperature Tₜ of 50° F. This time may be lesser or greater, depending for example on the flowrate of the pumps 116. FIG. 4 shows that, if the pumps were instead to continue pumping in cold water at temperature T₂, the water in the tub 102 would eventually reach steady state at temperature T₂. (39° F. in this example).

As noted, the degree of mixing of the water at temperatures T₁ and T₂ affects the time it takes to achieve the target temperature Tₜ. Hypothetically, if there were complete stratification of the water (no mixing of the volumes of water at the two different temperatures), the volume of water at T₁ could be completely drained or otherwise displaced as the volume of water at T₂ was pumped in. This would result in very rapid temperature change in tub 102 (nearly instantaneous as seen by the temperature sensor within the tub).

However, in reality, as the volume of water at T₂ is added, the volumes of water at T₁ and T₂ mix. The water drained or otherwise displaced from the tub 102 is therefore a mixture at a blended temperature, with the ratio of the volume of water at T₂ in the tub 102 increasing over time relative to the volume of water at T₁ as T₂ water is pumped in. Thus, the temperature of the water approaches T₂ asymptotically as shown by graph 122. The degree of mixing of the water is advantageously minimized in accordance with the present technology by pumping hot/cold water into the tub through the grate at the bottom and removing the blended temperature water from the tub over the top sides of the tub (or vice-versa).

In a similar manner, a contrast therapy session running by the control system 120 may signal that the temperature of the tub 102 is to cycle from a low current temperature T₁ to a higher (recovery) target temperature Tₜ by adding hot water at temperature T₂ from the hot tempered reservoir 106. The temperature in the tub would asymptotically rise to the target temperature Tₜ as the hot water is pumped into the tub 102 and the blended temperature water is removed. The control module would shut down the pumping of hot water when the temperature sensor in the tub 102 indicated that the target temperature Tₜ was achieved.

Another feature of the present technology resulting in fast temperature transitions in tub 102 is the simultaneous pumping of water into and out of the tub 102. For example, as explained below, the hot or cold pumps 116h, 116c may pump water into the tub 102 from the top sides of the tub as the drain pump 116d is draining water from the bottom of tub 102. In further embodiments explained below, water may be pumped into the tub 102 from the bottom and simply overflow out of the top sides of the tub.

In embodiments of the continuous immersion mode of operation, it is desirable to transition between the various temperatures of a contrast therapy session as quickly as possible. However, in a further embodiment, the temperature transition time is another parameter that may be controlled by the user. In such embodiments, when defining a contrast therapy session as explained below, another parameter to be set may be the transition time when raising or lowering the temperature of the water in the tub. A single transition time may be set for each temperature transition, or the user may set different transition times for different temperature transitions.

In a second mode of operation, referred to herein as drain and fill, all of the water at temperature T₁ is drained from the tub, and the tub 102 is then filled with water at the temperature T₂. The graph of this temperature change is shown by the dashed line 124 in FIG. 4.

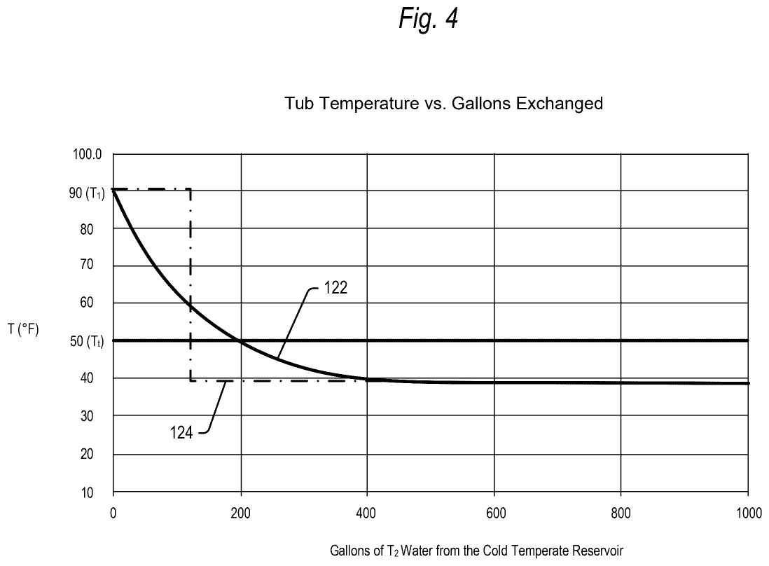

One issue with the drain and fill mode of operation is that water from the cold tempered reservoir 108 may be too cold (below the target temperature Tₜ) when refilling the tub in a temperature plunge cycle. Likewise, water from the hot tempered reservoir may be too hot (above the target temperature Tₜ) when refilling the tub in a recovery cycle. This issue may be addressed a number of ways. A first solution is to have an intermediate mixing tank 130 as shown in FIG. 5. Water from one or the other of the hot and cold tempered reservoirs 106, 108 may be pumped to the intermediate mixing tank, and then water from the other reservoir may be added until the target temperature Tₜ is achieved in the mixing tank 130. Water from the mixing tank may then be pumped into the tub 102 by one or mor pumps 116m. This process may be performed in advance of an upcoming cycle so that the water at the next target temperature Tₜ is sitting in the intermediate mixing tank 130 and ready to be pumped into the tub 102 after the current water is pumped out.

In another example, once the current volume of water is pumped from the tub 102, water from both the hot tempered and cold tempered reservoirs 106, 108 may be pumped into the tub 102 simultaneously and in proportionate volumes that result in the desired target temperature Tₜ when the hot and cold volumes of water mix in the tub. These respective volumes may be determined based on the theory of conservation of energy so that the heat lost from the incoming hot water is equal to the heat gained by the incoming cold water. The heat lost by the incoming hot water is given by:

$${m}_{1} c ( {T}_{h} - {T}_{t} ) \qquad ( Eq . 1 )$$

where m₁ is the mass of the incoming hot water, c is the specific heat capacity of water and Tₕ is the temperature of the water from the hot tempered reservoir. The heat gained by the incoming cold water is given by:

$${m}_{2} c ( {T}_{t} - {T}_{c} ) \qquad ( Eq . 2 )$$

where m₂ is the mass of the incoming cold water, c is the specific heat capacity of water and T_{c} is the temperature of the water from the cold tempered reservoir. As noted, under the theory of conservation of energy, the heat lost equals the heat gained so:

$${m}_{1} c ( {T}_{h} - {T}_{t} ) = {m}_{2} c ( {T}_{t} {T}_{c} ) \qquad ( Eq . 3 )$$

The specific heat capacity c may be dropped from both sides of the equation. Additionally, as the density of water is 1 kg/L, the mass, m, of the water in kilograms is numerically equal to the volume, V, of the water in liters. Thus, the equation simplifies to:

$${V}_{1} ( {T}_{h} - {T}_{t} ) = {V}_{2} ( {T}_{t} {T}_{c} ) \qquad ( Eq . 4 )$$

As an example, assume that the set temperatures in the hot and cold tempered reservoirs 106 and 108 are Tₕ=100° F. and T_{c}=40° F., and the desired target temperature in the tub is Tₜ=90° F. Plugging these temperatures into Equation 4 from above:

$${V}_{1} ( 100 - 90 ) = {V}_{2} ( 90 - 40 ) ;$$

$$10 {V}_{1} = {V}_{2} 50 , or$$

$${V}_{1} = 5 {V}_{2}$$

Thus, in this example, the volumetric flow rates from the hot and cold tempered reservoirs would be controlled so that the volume of water from the hot tempered 106 reservoir was 5 times the volume of water from the cold tempered reservoir 108. This may be achieved by a variety of methods, including positive displacement pumps.

Alternatively a given volume of water may be left in the tub (i.e., the tub is not fully evacuated), and hot or cold water is added from the reservoirs until the desired target temperature is achieved. Flow valves (not shown) may be used to control the respective flows as needed. The temperature sensor within the tub 102 may be used to provide closed loop feedback to the control system 120 to add more hot or cold water as needed to achieve or maintain the target temperature.

In further embodiments of the drain and fill mode of operation, the set point of the temperatures of the hot and cold tempered reservoirs 106, 108 may be maintained at the target cold plunge and recovery temperatures to be used within the tub. This embodiment does away with the need to adjust water temperatures from the reservoirs.

An advantage of the drain and fill mode of operation is that the bulk of mixing of tempered waters is omitted. This greatly reduces recovery times (if not removing it altogether) and greatly reduces power consumption of the system. Moreover, the one or more catch reservoirs 104 may be bypassed or omitted altogether.

The method of volumetric flow rate mixing described above for the drain and fill mode of operation may also be used in the continuous immersion mode of operation. Such an embodiment may use an intermediate mixing tank 130 as described above with respect to FIG. 5 to receive controlled volumes of water from the hot and cold tempered reservoirs, which is then pumped into the tub. Alternatively, controlled volumes of hot and cold water from the hot and cold tempered reservoirs may both be fed through a blending/mixing valve directly into the tub 102. The respective volumes of hot and cold water as determined by above equation 4 may be controlled for example by positive displacement pumps. Such an embodiment using the blending/mixing valve allows the hot tempered reservoir to be potentially maintained at a higher temperature than if the hot fluid were introduced directly into the tub. Likewise, such an embodiment using the blending/mixing valve allows the cold tempered reservoir to be potentially maintained at a lower temperature than if the cold fluid were introduced directly into the tub.

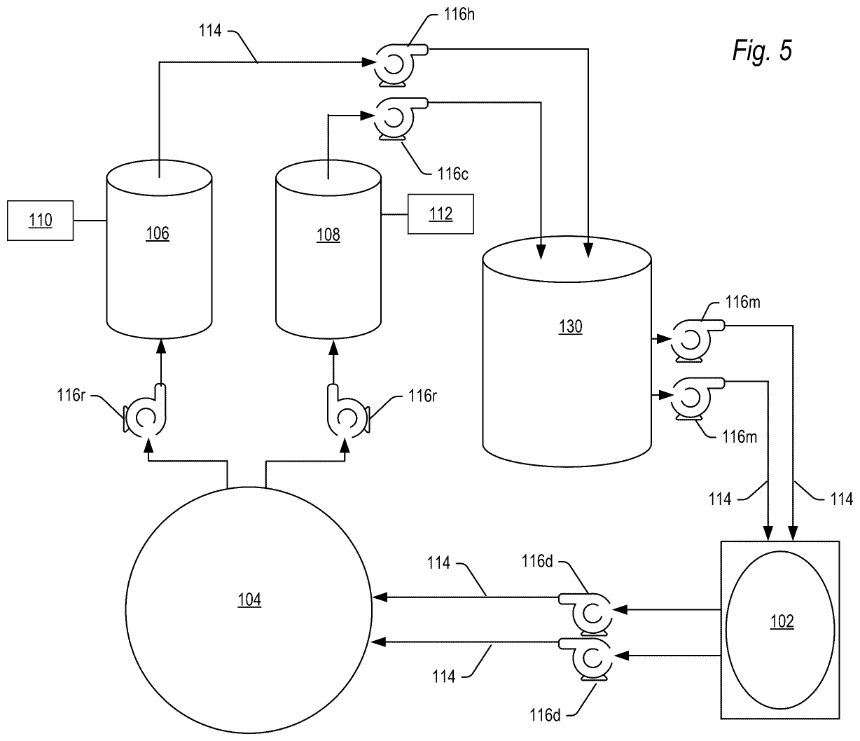

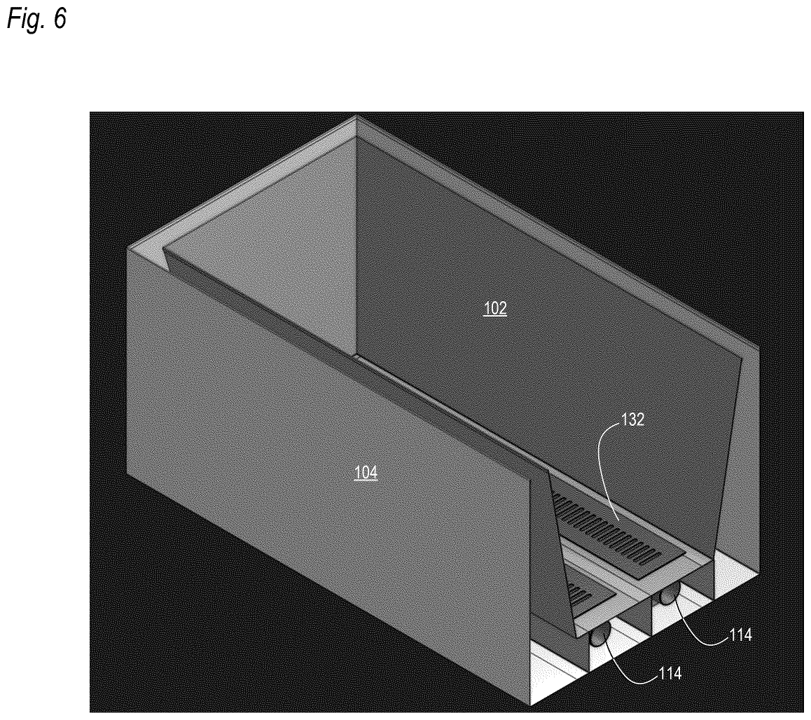

As noted above, during a cycle change in the tub, under either the continuous immersion mode or drain and fill mode, water is pumped out of the tub 102 by drain pump 116d. Referring to FIGS. 6 and 7, in embodiments, water is pumped out of the tub by drain pump 116d through grate 132 in the bottom of the tub 102. In this embodiment, the grate 132 is an example of an exit port. In the embodiment shown, the grate 132 may comprise a pair of slotted plates running substantially all of the length of the bottom of the tub 102. The grate 132 may comprise a single plate or more than two plate in further embodiments. The plates of the grate 132 may be positioned on the sides of the tub 102 in addition to, or possibly instead of, at the bottom of the tub 102 in further embodiments.

Referring to FIG. 7, when operating in the full immersion mode and water is drained from the tub through grate 132 by drain pump 116d, water from the hot or cold tempered reservoirs 106, 108 is pumped into the tub 102 over the top sides of the tub 102 as indicated by the arrows in FIG. 7. FIG. 7 shows a pipe 114 extending over the sides of the tub, but it is understood that a pipe 114 may bring the hot or cold water to the tub 102, and then various tubes or channels, possibly distributed around the tub, may carry the water over the sides and into the tub 102. In the drain and fill mode, water is drained from tub through grate 132 by drain pump 116d, and when the tub is empty, water from the hot and/or cold tempered reservoirs 106, 108 is pumped into the tub 102, for example over the top sides of the tub 102 as indicated by the arrows in FIG. 7.

In the embodiment of FIG. 7, the blended water may be pumped out through the grate 132 by drain pump 116d into the catch reservoir 104 beneath or adjacent to the tub 102. As noted, the simultaneous pumping of water into and out of the tub results in fast temperature transition times. However, in a further embodiment, the drain pump 116d may be omitted. In such an embodiment, a valve at or near the grate may open to allow water to drain through the grate 132 by gravity and into the catch reservoir 104 beneath the tub 102.

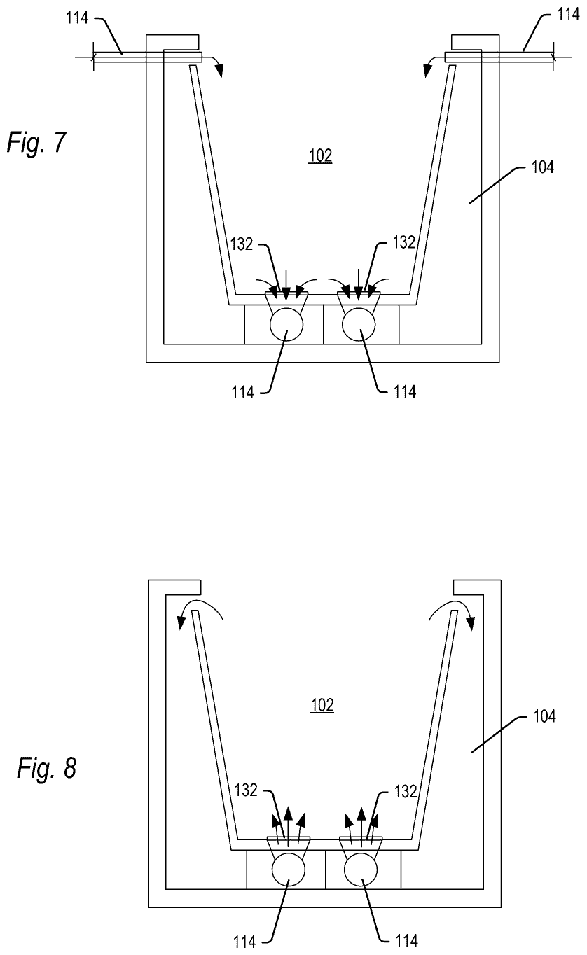

FIG. 8 shows a further embodiment for possible use in the continuous immersion mode. In this embodiment, water from the hot and/or cold tempered reservoirs 106, 108 is pumped into the tub through the grate 132 at the bottom of the tub 102 as shown by the arrows in FIG. 8. In this embodiment, the grate 132 is an example of an inlet port. In this embodiment, blended temperature water overflows the sides of the tub 102 and into the catch reservoir 104 beneath the tub 102. The drain pump 116d is omitted in this embodiment, except possibly to pump blended water from a catch reservoir 104 beneath the tub to a second catch reservoir 104 remote from the tub 102.

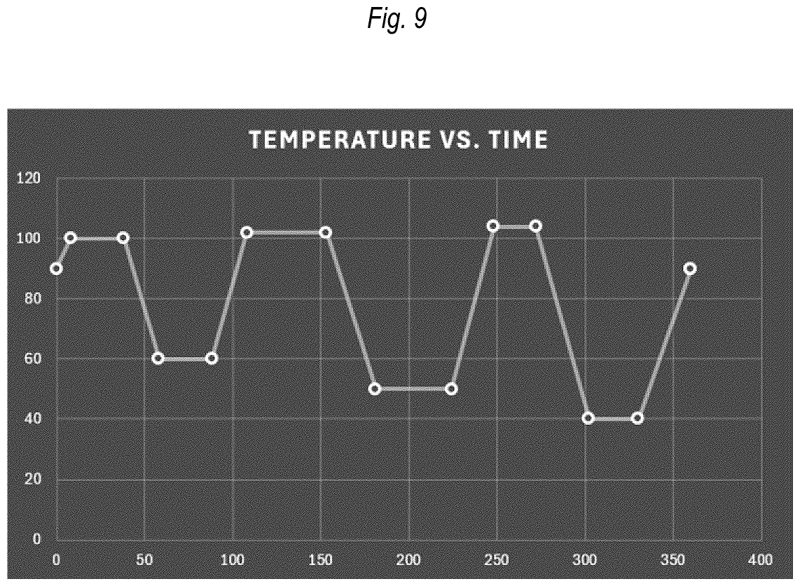

In use, a contrast therapy session may be selected or defined by a user, for example via a session control application 140 (FIG. 3) running on a user's smartphone, tablet, laptop or other smart device as explained below. A user is free to define a wide variety of temperature change cycles, but one example of a typical contrast therapy session is shown in the graph of FIG. 9. In this typical example, a user may enter the tub 102 with the water temperature set to 90° F. The user may remain at that temperature for a user-selected period of time. When ready, the user may hit a start button, for example from a user interface provided on their smart device as explained below, to begin the temperature cycling of the contrast therapy session.

In this example, upon starting the contrast therapy session, the temperature in the tub initially rises to 100° F. and remains there for 30 seconds. The session control application then begins a session including successive cycles of temperature plunge and plunge dwell, followed by temperature rise (or recovery) and recovery dwell. In this example, in the first cycle, there is a temperature plunge to 60° F. with a plunge dwell time of 30 seconds, followed by a temperature recovery to 102° F. with a recovery dwell time of 45 seconds. In a second cycle, there is a temperature plunge to 50° F. with a plunge dwell time of 43 seconds, followed by a temperature recovery to 104° F. with a recovery dwell time of 24 seconds. In a third cycle, there is a temperature plunge to 40° F. with a plunge dwell time of 28 seconds, followed by a temperature recovery to 90° F. This last temperature recovery marks the end of the contrast therapy session and the tub may remain at 90° F. until the user takes some further action.

As noted, this example of a contrast therapy session is just one of any of a wide variety of such sessions. These sessions may be predefined (stored) within the session control application, or they may be user defined. The number of cycles, the plunge and recover temperatures and the plunge and recovery dwell times may all vary in further embodiments. In the illustrated example, the plunge temperatures were successively lower for therapeutic effect, but it need not be in further embodiments.

For each temperature plunge in a cycle, cold water is pumped into the tub from the cold tempered reservoir 108 as blended temperature water is drained or otherwise displaced from the tub until the plunge temperature is achieved. The one or more cold tempered reservoirs 108 store enough cold water for all of the plunge cycles combined. Similarly, for each temperature recovery in a cycle, hot water is pumped into the tub from the hot tempered reservoir 106 as blended temperature water is drained or otherwise displaced from the tub until the recovery temperature is achieved. The one or more hot tempered reservoirs 106 store enough hot water for all of the recovery cycles combined. The one or more catch reservoirs 104 are large enough to store all water drained or otherwise displaced from the tub 102 for each temperature change cycle.

In the illustrated embodiment, there were three temperature cycles of plunge/recovery. The overall size (storage capacity) of the one or more hot and cold tempered reservoirs 106, 108 and one or more catch reservoirs 104 may be provided to handle three such cycles. Where a user wishes to employ more or significantly more than three temperature cycles, that user may opt for larger reservoirs 104, 106 and 108. The above-described contrast therapy sessions include a tub 102 sized to fit one or two users during a session. In further embodiments, there may be larger tubs 102, sized to fit more than two people. Or there may be multiple tubs 102, each sized to fit one or more people. In these embodiments, the overall size and/or number of reservoirs 104, 106 and 108 may be increased accordingly.

As noted above, all blended water drained or otherwise displaced from the tub with each temperature change remains in the one or more catch reservoirs 104, where it remains until completion of the session. At completion, the water within the one or more catch reservoirs 104 may be pumped by a refill pump 116r (FIG. 3) back to the hot and cold tempered reservoirs 106, 108, where the water is again heated and chilled over a prolonged period of time back to the set temperatures of the hot and cold tempered reservoirs 106, 108. The refilled water may also be filtered by filters (not shown).

In embodiments, water returned to the hot tempered reservoir 106 from the catch reservoir 104 is heated by the one or more heaters 110, and the water returned to the cold tempered reservoir 108 from the catch reservoir 104 is chilled by the one or more chillers 112. A potentially more efficient system uses a single, closed loop refrigerant unit to both heat the water returned to the hot temperature reservoir 106 and chill the water returned to the cold tempered reservoir 108. Such a closed loop refrigerant unit will now be described.

The closed loop refrigerant unit is potentially more efficient than separate heaters and chillers, as it employs a closed loop that uses the heat withdrawn from the water being transferred back to the cold tempered reservoir 108 to heat the water being transferred back to the hot tempered reservoir 106. First, the water in catch reservoir 104 is separated into a first reservoir to be heated and a second reservoir to be cooled. The water in the first and second reservoirs is then heated/cooled using the closed loop refrigerant unit, which comprises a heat pump system consisting of an evaporator, a compressor, a condenser, and an expansion valve. In embodiments, these first and second reservoirs may be the hot tempered reservoir 106 and cold tempered reservoir 108, or they may be separate reservoirs.

In the evaporator, the circulating refrigerant (such as water, glycol or a phase change refrigerant such as R-410A) absorbs heat from the water in second reservoir. For example, the refrigerant may be pumped through heat-exchange tubes passing through the water in the second reservoir. As the refrigerant absorbs heat, it evaporates, cooling the water in the second reservoir. In the compressor, the refrigerant is then compressed, which increases its temperature and pressure. The high-temperature, high-pressure circulating fluid then moves to the condenser, where it rejects heat to the first reservoir. For example, the refrigerant may be pumped through heat-exchange tubes passing through the water in the first reservoir. As the refrigerant releases heat, it condenses back into a liquid, heating the water in the first reservoir. The liquid refrigerant the passes through an expansion valve, which reduces its pressure and temperature, preparing it to absorb heat again in the evaporator in the next cycle.

The closed refrigerant loop conserves energy by leveraging the same energy to achieve both heating and cooling. Such a process may be more energy efficient than separate heaters and chillers that draw heat from, and expel heat to, ambient. Once water in the first and second reservoirs has reached its respective hot and cold set temperatures, it may be pumped back to the hot and cold tempered reservoirs 106, 108 (in embodiments here the heat transfer reservoirs were separate from the hot and cold tempered reservoirs).

It may happen that the temperature of the water in one of the first and second reservoirs reaches its set temperature before the other. In this case, the refrigerant loop would change from water:water heat transfer to either water:air heat transfer (cooling) or air:water heat transfer (heating) mode once one reservoir's condition is satisfied. In the water:air heat transfer operation, the chiller 112 may be used as described above. In the air:water heat transfer operation, the heater 110 may be used as described above.

In embodiments described above, water may be moved between the tub 102 and various reservoirs 104, 106 and 108 by pumps. In further embodiments, pressurized containers may be used in the place of pumps. These pressurized containers may be pressurized to a negative pressure or vacuum, or to a positive pressure greater than ambient. Thus, as one example, a negative pressure or vacuum container may be connected to the drain 132 in the place of pumps 116d. When it is desired to drain water from the tub 102, a drain valve between the tub 102 and the negative pressure container may be opened, thus actively pulling water from the tub above and beyond the gravitational and atmospheric forces acting to drain water from the tub. Other positive and/or negative pressurized containers may be used elsewhere in the system 100 to move water to or from the tub or various reservoirs 104, 106 and 108.

In embodiments described above, there may be a single working media that is directly heated and cooled (i.e., the water being transferred between tub 102 and reservoirs 104, 106, 108). In a further embodiment, there may be primary media (the water that enters and leaves the tub), and a secondary media that heats/cools the primary media. The secondary media may be water as in the primary media, or the secondary media may be some other liquid such as glycol.

The secondary media may be heated and stored in the hot tempered reservoir. In order to heat the primary media, the primary and heated secondary media are fed to a first heat exchanger, within the hot tempered reservoir or elsewhere. Heat is transferred from the heated secondary media to the primary media within the first heat exchanger. The primary media may be pumped through the first heat exchanger at a controlled and variable rate to control the temperature of the primary media. In this embodiment, the temperature of the heated secondary media may optionally be hotter than in embodiments where the hot water is fed directly from the hot tempered reservoir to the tub.

The secondary media may also be chilled and stored in the cold tempered reservoir. In order to cool the primary media, the primary and chilled secondary media are fed to a second heat exchanger, within the cold tempered reservoir or elsewhere. Heat is transferred from the primary media to the chilled secondary media within the second heat exchanger. The primary media may be pumped through the second heat exchanger at a controlled and variable rate to control the temperature of the primary media. In this embodiment, the temperature of the chilled secondary media may optionally be colder than in embodiments where the cold water is fed directly from the cold tempered reservoir to the tub. In embodiments, the first and second heat exchangers may be different components, or there may be a single heat exchanger that operates for both heating and cooling the primary media.

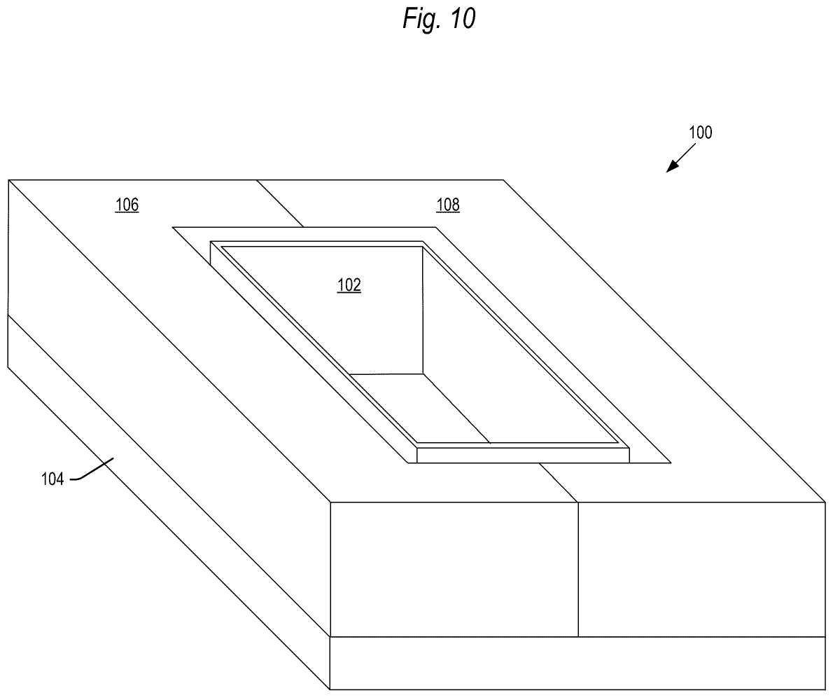

The embodiment of the system 100 shown in FIGS. 1 and 2 includes a distributed system including the tub 102 and hot, cold and catch reservoirs 104, 106 and 108 spaced apart from each other, for example on a deck or in a yard of a user. In further embodiments, the components of system 100 may be integrated into a single unit, as shown for example in FIG. 10. FIG. 10 shows the hot and cold tempered reservoirs 106, 108 surrounding tub 102, with the catch reservoir 104 mounted beneath the tub 102 and reservoirs 106, 108. The various pumps, heaters and chillers may be integrated within the interior, or on the side, of the integrated system 100, and control circuitry may be mounted on one of the sides of the integrated system 100. In embodiments, the integrated system 100 may have a form factor of conventional spas, but the length, width and/or depth may each vary in different embodiments.

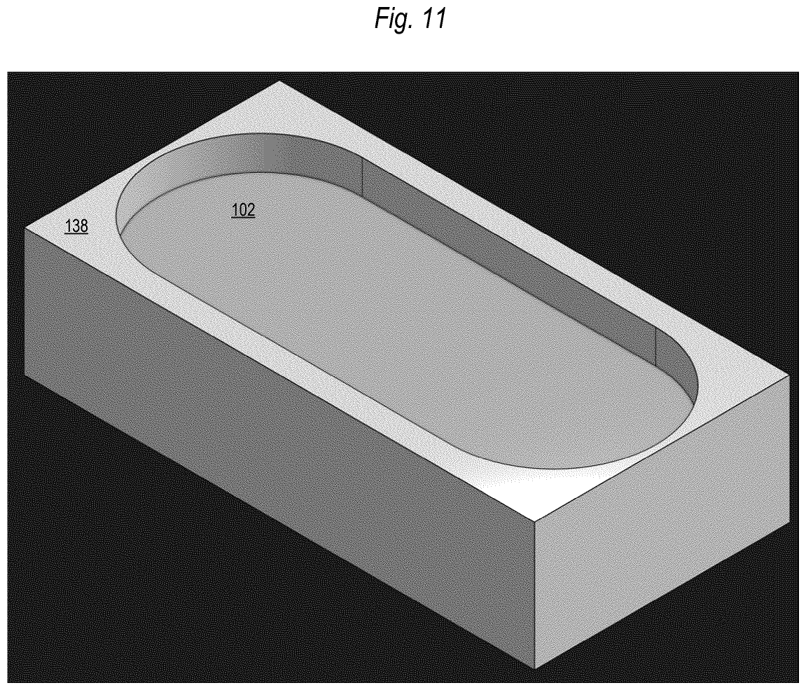

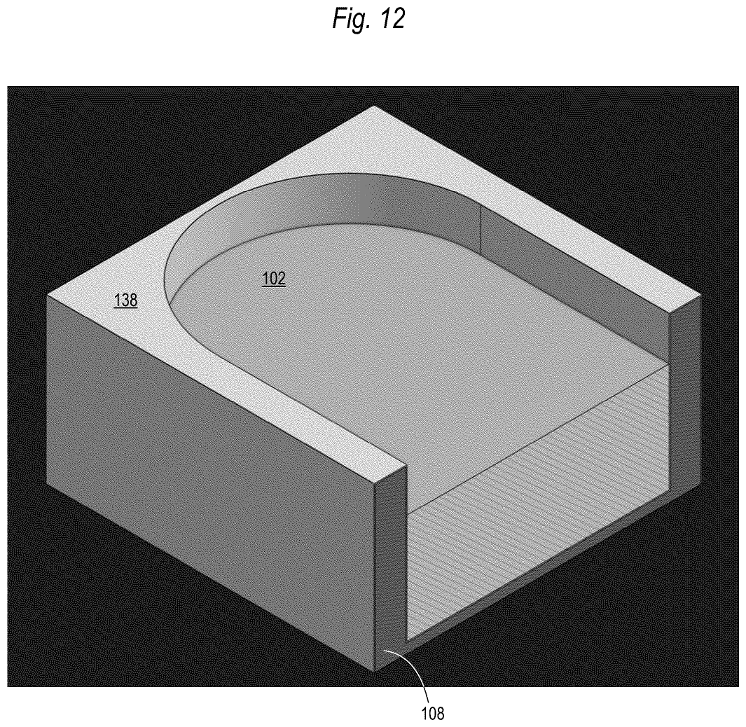

The embodiment of the system 100 shown in FIGS. 1 and 2 includes a distributed system for installation in a yard or otherwise exterior to a home. In further embodiments, the system 100 may be configured for in-home use. Such an embodiment is shown in FIGS. 11 and 12. In this embodiment, the tub 102 may be surrounded by a hollow enclosure 138 which can serve as a reservoir for supplying tempered water to tub 102. In embodiments, the hollow enclosure 138 may serve as the cold tempered reservoir 108, as most homes have a hot water heater with a ready supply of hot water. The tub 102 may be plumbed to the home's hot water heater. In one example of use, ground water or domestic hot water may be pumped into the tub (from the home's plumbing or a pump associated with the system 100) to displace chilled water in the tub, or chilled water in the enclosure 138 around the tub. It is conceivable that water would be added with a dip tube to maximize stratification of hot and cold water. This approach could utilize a blending valve as previously described to maximize use of a small volume reservoir held at a cold temperature.

The catch reservoir 104 may be omitted in this embodiment, so that upon a temperature change in the tub 102, the blended temperature water drains from the tub and is expelled through the home's plumbing drainage pipes. Upon completion of a contrast therapy session, water may be returned to the hollow enclosure 138 from the home's water supply, where it may then for example be chilled to the set temperature of the cold tempered reservoir 108.

Most homes are equipped with a hot water heater and hot water supply. In a further embodiment of the present technology, homes may further be equipped with a residential cold water chiller such that a residence (or scaled up for hotel, multi-family apartment buildings, etc.) can be equipped with a tempered reservoir of chilled water as well as hot. This device would function similarly to a residential water heater, but with a dip tube operating in reverse such that ground water was introduced to the top of the vessel and displacing chilled water out of the bottom (from the dip tube). In such embodiments, the residential hot water heater and chiller may be used in the place of the hot and cold tempered reservoirs 106, 108 in any of the embodiments described herein.

The embodiment of FIGS. 11 and 12 has the advantage of in-home use and may take up the same space as a conventional tub. A further advantage is the omission of separate hot tempered and catch reservoirs, as well as a separate heater for the hot tempered reservoir and/or chiller for the cold tempered reservoir. The pump for pumping tempered water from enclosure 138 may be integrated within the interior of the system 100, and control circuitry may be mounted somewhere near the integrated system 100. In this example, the control circuitry may for example be integrated into a wall-mounted unit near the tub 102. This approach too could utilize a blending valve as previously described to maximize use of a small volume reservoir held at a cooler than used temperature

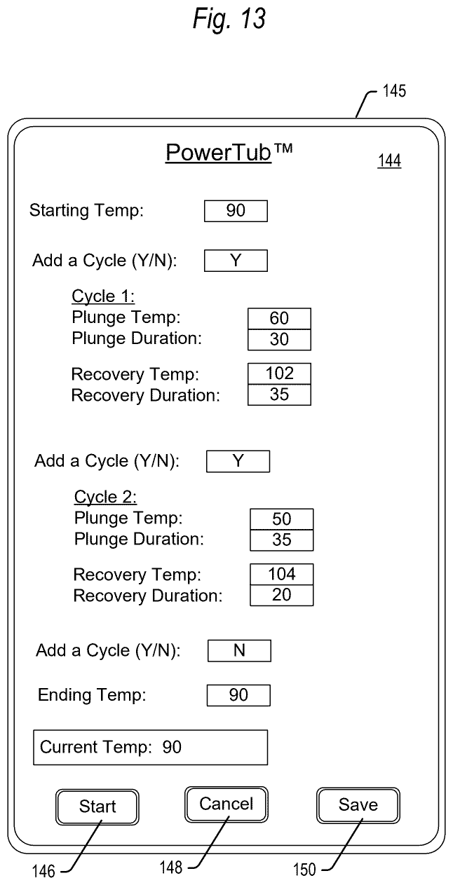

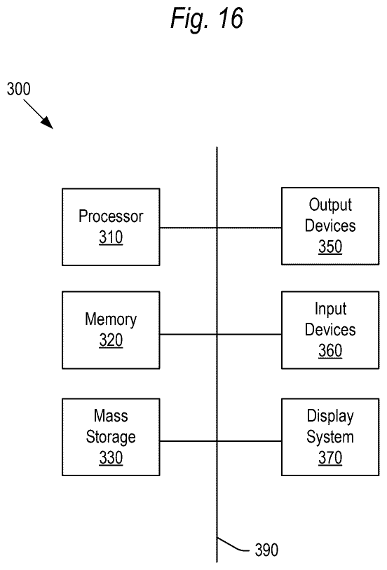

A further aspect of the present technology relates to a session control application 140 (FIG. 3) for the controlling the operation of the system 100 and for implementing the contrast therapy sessions explained above. In one embodiment, the session control application 140 may be a downloadable software application for execution on a smart device including for example a smart phone, tablet, laptop and desktop computers. And example architecture for such a smart device is shown in FIG. 16 described below. When operating on a smart device, the session control application 140 may present a graphical user interface (GUI) on a display of the device. A simple example GUI 144 running on a smart device 145 is shown in FIG. 13. The GUI 144 shows a tradename, PowerTub™, for the present system, together with a menu allowing a user to set the parameters of a contrast therapy session.

For example, the GUI 144 allows a user to set the starting and ending temperatures for session, and then add one or more cycles each consisting of a plunge temperature, a recovery temperature, and the durations at the plunge and recovery temperatures. The user is given the option to set as many cycles as desired. The GUI 144 further includes a start button 146 for starting the defined contrast therapy session, a cancel button 148 for canceling a started or defined contrast therapy session, and a save button 154 saving a defined contrast therapy session for future use.

The GUI 144 shown in FIG. 13 is one simple example, and the session control application may present a GUI 144 having a wide variety of other appearances and include additional and/or alternative functionality. In addition to contrast therapy sessions saved by a user, the session control application 140 may further include stored, predefined contrast therapy sessions from which the user can choose. The session control application may include a wide variety of other functions including for example monitoring and displaying the temperature of the water in tub 102, and tracking maintenance schedules for the various components of the system 100.

The session control application 140 may further include a network interface for communicating with the control system 120 as indicated in FIG. 3 (as well as the Internet and other networked smart devices). This communication may be for example by a WiFi, Bluetooth or cellular network connection. The control system 120 may be implemented on computing device including a processor and memory, further details of which are explained with respect to FIG. 16 below. The control system 120 and/or session control application 140 may monitor the operation and functioning of all components within the system 120. Thus, as indicated, the control system 120 and/or session control application 140 may receive feed back from various temperature sensors and level sensors in the tub 102, the one or more catch reservoirs 104 and/or the one or more hot and cold tempered reservoirs 106, 108. The control system 120 and/or session control application 140 may additionally receive feedback on the operating state (e.g., on or off) of the one or more heaters 110, chiller 112 and system pumps 116, as well as the operational position of valves controlling the flow of water through the system.

In operation, once a contrast therapy session begins, the session control application 140 sends a signal to the control system 120, which in turn activates the pumps 116h (to raise the temperature in the tub) or pumps 116c (to lower the temperature in the tub), as well as pumps 116d (to drain the water into a catch reservoir). One or more temperature sensors may be positioned in the tub 102 to provide closed-loop temperature feedback to the control system so that the control system can turn off the pump(s) when the target temperature is reached in the tub 102. The session control application 140 and/or control system 120 further includes a clock to measure dwell times. Upon expiration of a dwell time, the session control application 140 again sends a signal to the control system to activate the appropriate pumps. This process continues until completion of the contrast therapy session. The session control application 140 may further provide users the option to bypass one or more temperature cycles in the defined in the contrast therapy session.

In further embodiments, the session control application 140 may download a contrast therapy session to the memory in the control system 120, which then executes the contrast therapy session without further need of communication from the session control application. In this example, the session control application 140 may still be used to cancel a contrast therapy session being executed by the control system 120.

At the completion (or possibly cancellation) of a contrast therapy session, the control system 120 may further control the return of the blended temperature water from the one or more catch reservoirs 104 to the hot and cold tempered reservoirs 106, 108. The various reservoirs 104, 106 and 108 may each include temperature sensors and sensors indicating the water level in the reservoir. After completion of a contrast therapy session, the control system 120 may initiate the one or more pumps 116r to pump water from the one or more catch reservoirs 104 into each of the hot and cold tempered reservoirs 106, 108 until the level sensors in each reservoir 106, 108 indicates the reservoir is full, or at some predefined level. At that point, the control system 120 may shut down the one or more pumps 116r. The control system 120 may then activate the heater 110 to heat the water in reservoir 106 until the temperature sensor in reservoir 106 indicates that the set temperature has been reached. Likewise, the control system 120 may activate the chiller 112 to cool the water in reservoir 108 until the temperature sensor in reservoir 108 indicates that the set temperature has been reached. The system 100 is then ready for its next use.

One advantage of the session control application 140 running on a smart device such as a user's smart phone is that the user can control their user experience with the PowerTub system 100 entirely from their phone. Moreover, a user may travel to multiple different PowerTub systems at different locations. It is a further advantage of the present technology that the session control application 140 can communicate with the control system 120 at any PowerTub system 100. Thus, users are able to customize their user experience to their own preferences at any PowerTub system to which the users travel.

In further embodiments, users may be given the option to store their customized contrast therapy sessions in a central database accessible to all users via the Internet. The users may also provide categories of ailments (fatigue, muscle soreness, etc.) which the customized contrast therapy session is effective at treating. This allows users to access their customized sessions when they do not have access to their own smart devices. This also creates a central database of categorized and customized contrast therapy sessions from which users can select to customize their own user experience.

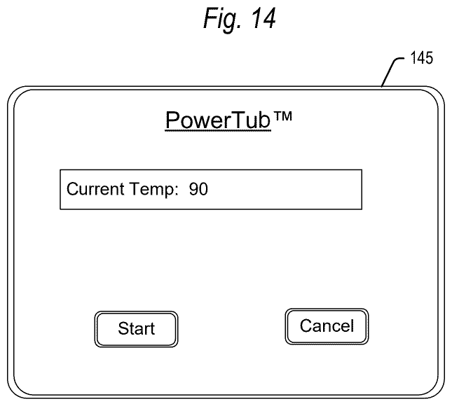

FIG. 14 shows a further example of a simplified smart device 145 capable of performing at least some of the functionality of the session control application 140. In this example, the smart device 145 may be a dedicated device (having no use independent of the PowerTub system 100). In this example, the simplified smart device 145 may include a display, for example for showing the current temperature within the tub 102. It may display other parameters of a session, including target temperature and dwell time at that target temperature. The simplified smart device 145 may further include start and cancel buttons for initiating and stopping contrast therapy sessions. The simplified smart device 145 of FIG. 14 may optionally store one or more predefined or user-defined contrast therapy sessions that can be executed by the simplified smart device 145.

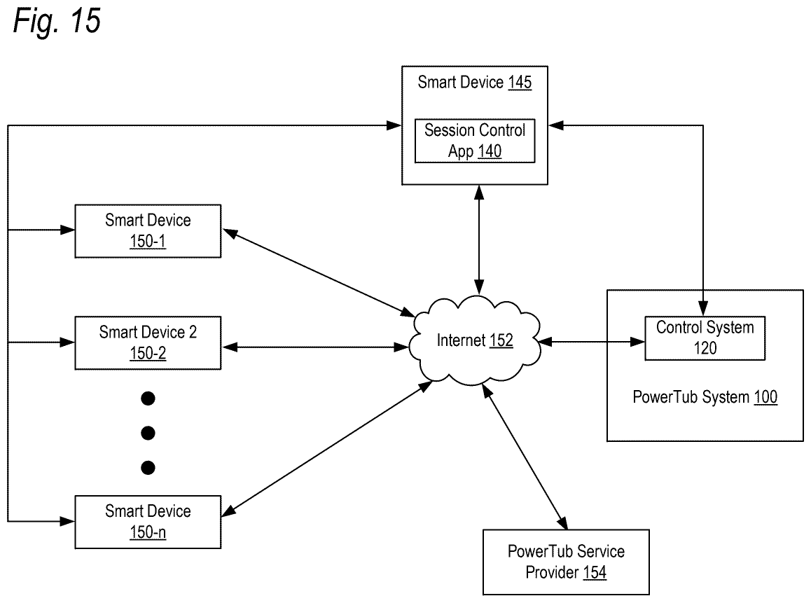

In embodiments, the PowerTub system 100 may operate with the smart device 145 as an isolated system. However, in further embodiments, the PowerTub system 100 and smart device 145 may operate as part of a larger ecosystem of connected smart devices. Such an embodiment will now be described with reference to FIG. 15.

FIG. 15 shows a number of smart devices 150-1, 150-2, . . . , 150-n which measure or receive feedback on various physiological traits of a user. The devices may for example be wearable devices such as smart watches, clothing and rings, and in combination may for example be used to determine physiological traits such as heart rate, respiratory rate, blood oxygen levels, blood pressure, body temperature, sleep patterns, stress levels, etc. The devices 150 may have a network connection to the smart device 145 executing the session control application 140. The network connection may be local such as a WiFi connection or Bluetooth, or wide area such the Internet 152.

Historical data may show that certain physiological traits or symptoms of a user are indicative of a certain physical or mental state. Using this historical data, the data measured by the smart devices 150 may be collected and analyzed, for example by the session control app 140, to assess a current physical and/or mental condition of the user. Additionally, historical data may show that certain contrast therapy session recipes are effective at soothing and treating certain physical and/or mental conditions. These physical and/or mental states and their associated optimized contrast therapy session recipe may be stored in memory of the smart device 145 by the session control app 140. Thus, once the physical and/or mental state of the user is determined, the associated contrast therapy session for soothing/treating that state is selected from memory and implemented by the session control application 145. Thus, the ecosystem may for example be used to collect data showing that a user is stressed, or has slept poorly, and select a contrast therapy session optimized to sooth/treat these conditions.

In further embodiments, the ecosystem may further include a PowerTub service provider 154 which includes one or more centralized servers which collect the data from smart devices 150 (and possibly the smart devices 150 of other users), maps the measured data to a current physical and/or mental state of the user, and selects a contrast therapy session optimized to sooth/treat that state. The PowerTub service provider 154 (and the session control app 140) may be updated over time as new contrast therapy sessions are developed and shown to be effective at soothing/treating exhibited physical and/or mental states.

In embodiments, all of the above-described componentry (including pumps/valves/control module/reservoirs/heaters/chillers may be assembled at a property where the PowerTub system 100 is to be installed. In a further embodiment, all of the above-described componentry may be preassembled into a pre-packaged solution which can be retrofitted into an existing hot tub or the like to transform the existing hot tub or the like into a PowerTub system 100 as described herein.

Additionally, in further embodiments, the combination of the above-described componentry may operate with inflatable, collapsible or otherwise portable versions of the tub and reservoirs such that it is able to be relocated.

FIG. 16 illustrates an exemplary computing system 300 that may for example be the system controller 120 and/or the smart device 145. The computing system 300 of FIG. 16 includes one or more processors 310 and main memory 320. Main memory 320 stores, in part, instructions and data for execution by processor unit 310. Main memory 320 can store the executable code when the computing system 300 is in operation. The computing system 300 of FIG. 16 may further include a mass storage device 330, portable storage medium drive(s) 340, output devices 350, user input devices 360, a display system 370, and other peripheral devices 380.

The components shown in FIG. 16 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a magnetic disk drive, an optical disk drive or a solid state drive, is a non-volatile storage device for storing data and instructions for use by processor unit 310. Mass storage device 330 can store BLU and other algorithms for implementing embodiments of the present technology and for loading that software into main memory 320.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 16 includes output devices 350. Suitable output devices include speakers, network interfaces, and a display.

Display system 370 may include a liquid crystal display (LCD) or other suitable display device. Display system 370 receives textual and graphical information, and processes the information for output to the display device.

The components contained in the computing system 300 of FIG. 16 are those typically found in computing systems that may be suitable for use with embodiments of the present invention and are intended to represent a broad category of such computer components that are well known in the art. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a USB drive, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, in one example, the present technology relates to a system, comprising: a tub, the tub comprising an inlet port at or adjacent to a bottom of the tub; a hot tempered reservoir storing water at a first temperature; a cold tempered reservoir storing water at a second temperature lower than the first temperature; pipes connecting the hot and cold tempered reservoirs to the inlet port at the bottom of the tub; pumps for pumping water from the hot and cold tempered reservoirs to the inlet port at the bottom of the tub; wherein the system is configured to change a temperature of water in the tub from a current temperature to a target temperature by pumping water from one of the hot and cold tempered reservoirs into the tub through the inlet port, the pumping of water from one of the hot and cold tempered reservoirs into the tub through the inlet port causing water to overflow top sides of the tub, and wherein the system is further configured to stop the pumping of water from one of the hot and cold tempered reservoirs into the tub through the inlet port when water in the tub reaches the target temperature.

In a further example, the present technology relates to a system, comprising: a tub, the tub comprising a port at a bottom of the tub; a hot tempered reservoir storing water at a first temperature; a cold tempered reservoir storing water at a second temperature lower than the first temperature; a catch reservoir for receiving water evacuated from the tub; pipes connecting the hot and cold tempered reservoirs to the tub to introduce the water into the tub and to evacuate water from the tub; a first set of one or more pumps for pumping water from the hot tempered reservoir to the tub; a second set of one or more pumps for pumping water from the cold tempered reservoir into the tub; a first temperature sensor within the tub for sensing a temperature of water within the tub; a second temperature sensor within the hot tempered reservoir for sensing a temperature of water in the hot tempered reservoir; a third temperature sensor within the cold tempered reservoir for sensing a temperature of water in the hot tempered reservoir; a control system comprising one or more processors for selecting one of the first and second pumps to pump water from one of the hot and cold tempered reservoirs to mix with water in the tub, the selection depending on a defined target temperature of water in the tub, the water from one of the hot and cold tempered reservoirs driving a temperature of water in the tub asymptotically to the target temperature, the one or more processors further receiving closed loop feedback from the first temperature sensor in the tub to shut off operation of the selected one of the first or second sets of one or more pumps when the first temperature sensor in the tub indicates to the one or more processors that the target temperature in the tub has been achieved.

In another example, the present technology relates to a system, comprising: a tub, the tub comprising an exit port at a bottom of the tub; a hot tempered reservoir storing water at a first temperature; a cold tempered reservoir storing water at a second temperature lower than the first temperature; a catch reservoir for receiving water evacuated from the tub through the exit port; pipes connecting the hot and cold tempered reservoirs to the tub to introduce the water into the tub over top sides of the tub; a set of one or more pumps for pumping water from the hot and cold tempered reservoirs to the tub; a negative pressure container connected to the exit port for pulling water out of the tub through the exit port and the negative pressure container when the negative pressure container is opened to the tub; wherein the system is configured to change a temperature of water in the tub from a current temperature to a target temperature by pumping water from one of the hot and cold tempered reservoirs into the tub over the top sides of the tub and by pumping water out of the tub through the exit port; and wherein the system is further configured to stop the pumping of water into and out of the tub when water in the tub reaches the target temperature.

In a further example, the present technology relates to a system comprising a tub, a hot tempered reservoir with hot water, a cold tempered reservoir with cold water and pumps for pumping hot and cold water to the tub from the hot and cold tempered reservoirs, the system further comprising: a memory storing an application program; one or more processors configured to implement the application program to: provide a graphical user interface configured to receive a starting temperature of water in an immersive tub contrast therapy session; receive, via the graphical user interface, a first temperature cycle for the contrast therapy session comprising a first target temperature, a first dwell time at the first target temperature, a second target temperature different than the first target temperature, and a second dwell time at the second target temperature; receive, via the graphical user interface, at least one second temperature cycle for the contrast therapy session comprising a third target temperature, a third dwell time at the third target temperature, a fourth target temperature different than the third target temperature, and a fourth dwell time at the fourth target temperature; control the pumps to turn on one or more of the pumps to pump water from the hot and cold tempered reservoirs into the tub at different times to achieve the first, second, third and fourth target temperatures in the tub, and control the pumps to turn off the one or more pumps upon achieving the first, second, third and fourth target temperatures.

In another example, the present technology relates to an ecosystem comprising a tub, a hot tempered reservoir with hot water, a cold tempered reservoir with cold water and pumps for pumping hot and cold water to the tub from the hot and cold tempered reservoirs, the system further comprising: a first group of one or more smart devices configured to collect data on the physiological traits of a user, the physiological traits indicative of a physical and/or mental state of a user; a second group of one or more smart devices comprising: a memory storing an application program; one or more processors configured to: implement the application program to receive the data on the physiological traits of the user and select a contrast therapy session optimized to sooth or treat the physical and/or mental state of the user; control the one or more pumps to turn on and off the one or more of the pumps to pump water from the hot and cold tempered reservoirs into the tub at different times to implement the selected contrast therapy session.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

We claim:

1. A system, comprising:
a tub, the tub comprising an inlet port at or adjacent to a bottom of the tub;
a hot tempered reservoir storing water at a first temperature;
a cold tempered reservoir storing water at a second temperature lower than the first temperature;
pipes connecting the hot and cold tempered reservoirs to the inlet port at the bottom of the tub;
pumps for pumping water from the hot and cold tempered reservoirs to the inlet port at the bottom of the tub;
wherein the system is configured to change a temperature of water in the tub from a current temperature to a target temperature by pumping water from one of the hot and cold tempered reservoirs into the tub through the inlet port, the pumping of water from one of the hot and cold tempered reservoirs into the tub through the inlet port causing water to overflow top sides of the tub, and
wherein the system is further configured to stop the pumping of water from one of the hot and cold tempered reservoirs into the tub through the inlet port when water in the tub reaches the target temperature.

2. The system of claim 1, further comprising a catch reservoir for catching water overflowing the sides of the tub.

3. The system of claim 1, wherein mixing of the water at the current temperature and water at one of the first and second temperatures from one of the hot and cold tempered reservoirs causes the temperature of the water in the tub to approach the target temperature asymptotically.

4. The system of claim 3, wherein introduction of hot or cold water through the inlet port and removal of the current water over the top sides of the tub minimizes mixing of the hot or cold water with the current water.

5. The system of claim 1, further comprising a control system for monitoring a temperature of the water in the tub as water is pumped in from one of the hot and cold tempered reservoirs by one of the pumps, and shutting down the pump when the temperature in the tub reaches the target temperature.

6. The system of claim 5, further comprising a temperature sensor within the tub providing closed loop feedback to the control system as to the temperature of the water in the tub.

7. The system of claim 1, wherein at least one of the hot and cold tempered reservoirs are physically spaced from the tub and connected by the pipes.

8. The system of claim 1, where at least one of the hot and cold tempered reservoirs are integrated into an overall form factor of the tub.

9. The system of claim 8, wherein the system is configured for in-home use.

10. A system, comprising:
a tub, the tub comprising a port at or adjacent to a bottom of the tub;
a hot tempered reservoir storing water at a first temperature;
a cold tempered reservoir storing water at a second temperature lower than the first temperature;
a catch reservoir for receiving water evacuated from the tub;
pipes connecting the hot and cold tempered reservoirs to the tub to introduce the water into the tub and to evacuate water from the tub;
a first set of one or more pumps for pumping water from the hot tempered reservoir to the tub;
a second set of one or more pumps for pumping water from the cold tempered reservoir into the tub;
a first temperature sensor within the tub for sensing a temperature of water within the tub;
a second temperature sensor within the hot tempered reservoir for sensing a temperature of water in the hot tempered reservoir;
a third temperature sensor within the cold tempered reservoir for sensing a temperature of water in the hot tempered reservoir;
a control system comprising one or more processors for selecting one of the first and second pumps to pump water from one of the hot and cold tempered reservoirs to mix with water in the tub, the selection depending on a defined target temperature of water in the tub, the water from one of the hot and cold tempered reservoirs driving a temperature of water in the tub asymptotically to the target temperature, the one or more processors further receiving closed loop feedback from the first temperature sensor in the tub to shut off operation of the selected one of the first or second sets of one or more pumps when the first temperature sensor in the tub indicates to the one or more processors that the target temperature in the tub has been achieved.

11. The system of claim 10, further comprising a third set of one or more pumps for pumping water out of the tub from the port at the bottom of the tub, under control of the one or more processors, the pumping of water from the tub by the third set of one or more pumps decreasing a time it takes for water in the tub to reach the target temperature.

12. The system of claim 10, further comprising a fourth set of one or more pumps for pumping water from the catch reservoir to at least one of the hot and cold tempered reservoirs, under control of the one or more processors.

13. The system of claim 10, further comprising level sensors for sensing a level of water in the hot and cold tempered reservoirs, the level sensors providing closed loop feedback to the one or more processors to stop the operation of the fourth set of one or more pumps when the level sensors indicate that a level of water in hot and cold tempered reservoirs has reached defined levels.

14. The system of claim 10, wherein at least one of the hot and cold tempered reservoirs are physically spaced from the tub and connected by the pipes.

15. The system of claim 10, where at least one of the hot and cold tempered reservoirs are integrated into an overall form factor of the tub.

16. The system of claim 15, wherein the system is configured for in-home use.

17. The system of claim 10, wherein the control system receives instructions from a software application executing on a smart device of a user using the tub.

18. A system, comprising:
a tub, the tub comprising an exit port at or adjacent to a bottom of the tub;
a hot tempered reservoir storing water at a first temperature;
a cold tempered reservoir storing water at a second temperature lower than the first temperature;
a catch reservoir for receiving water evacuated from the tub through the exit port;
pipes connecting the hot and cold tempered reservoirs to the tub to introduce the water into the tub over top sides of the tub;
a set of one or more pumps for pumping water from the hot and cold tempered reservoirs to the tub;
a negative pressure container connected to the exit port for pulling water out of the tub through the exit port and the negative pressure container when the negative pressure container is opened to the tub;
wherein the system is configured to change a temperature of water in the tub from a current temperature to a target temperature by pumping water from one of the hot and cold tempered reservoirs into the tub over the top sides of the tub and by pumping water out of the tub through the exit port; and
wherein the system is further configured to stop the pumping of water into and out of the tub when water in the tub reaches the target temperature.

19. The system of claim 18, wherein mixing of the water at the current temperature and water at one of the first and second temperatures from one of the hot and cold tempered reservoirs causes the temperature of the water in the tub to approach the target temperature asymptotically.

20. The system of claim 19, wherein introduction of hot or cold water at the top sides of the tub and removal of the current water through the exit port minimizes mixing of the hot or cold water with the current water.

21. The system of claim 18, further comprising a control system for monitoring a temperature of the water in the tub as water is pumped in from one of the hot and cold tempered reservoirs by one of the pumps, and shutting down the pump when the temperature in the tub reaches the target temperature.

22. The system of claim 21, further comprising a temperature sensor within the tub providing closed loop feedback to the control system as to the temperature of the water in the tub.

23. A system comprising a tub, a hot tempered reservoir with hot water, a cold tempered reservoir with cold water and pumps for pumping hot and cold water to the tub from the hot and cold tempered reservoirs, the system further comprising:
a memory storing an application program;
one or more processors configured to implement the application program to:
provide a graphical user interface configured to receive a starting temperature of water in an immersive tub contrast therapy session;
receive, via the graphical user interface, a first temperature cycle for the contrast therapy session comprising a first target temperature, a first dwell time at the first target temperature, a second target temperature different than the first target temperature, and a second dwell time at the second target temperature;
receive, via the graphical user interface, at least one second temperature cycle for the contrast therapy session comprising a third target temperature, a third dwell time at the third target temperature, a fourth target temperature different than the third target temperature, and a fourth dwell time at the fourth target temperature;
control the pumps to turn on one or more of the pumps to pump water from the hot and cold tempered reservoirs into the tub at different times to achieve the first, second, third and fourth target temperatures in the tub; and
control the pumps to turn off the one or more pumps upon achieving the first, second, third and fourth target temperatures.

24. The system of claim 23, wherein the memory and the one or more processors are implemented on a smart device.

25. The system of claim 24, wherein the smart device is one of a smart phone, tablet, laptop and desktop computer.

26. The system of claim 23 wherein the memory and the one or more processors are implemented on a control system for controlling operation of the system.

27. The system of claim 23 wherein the memory and the one or more processors are implemented on a smart device and a control system for controlling operation of the system, the system further comprising a network connection between the smart device and the control system.

28. The system of claim 23, the one or more processors further configured to receive temperature measurements from a temperature sensor in the tub to determine when the first, second, third and fourth target temperatures are achieved.

29. The system of claim 23, wherein the pumps for pumping hot and cold water to the tub from the hot and cold tempered reservoirs comprise a first set of pumps, the system further comprising a catch reservoir and a second set of pumps for pumping water from the catch reservoir back to the hot and cold tempered reservoirs, wherein the one or more processors control the second set of pumps to pump the water back to the hot and cold tempered reservoirs after completion of the contrast therapy session.

30. The system of claim 29, further comprising level sensors within the hot and cold tempered reservoirs, the one or more processors receiving closed loop feedback from the level sensors to determine when to stop the second set of pumps from pumping water back to the hot and cold tempered reservoirs.

31. An ecosystem comprising a tub, a hot tempered reservoir with hot water, a cold tempered reservoir with cold water and pumps for pumping hot and cold water to the tub from the hot and cold tempered reservoirs, the system further comprising:
a first group of one or more smart devices configured to collect data on the physiological traits of a user, the physiological traits indicative of a physical and/or mental state of a user;
a second group of one or more smart devices comprising:
a memory storing an application program;
one or more processors configured to:
implement the application program to receive the data on the physiological traits of the user and select a contrast therapy session optimized to sooth or treat the physical and/or mental state of the user;
control the one or more pumps to turn on and off the one or more of the pumps to pump water from the hot and cold tempered reservoirs into the tub at different times to implement the selected contrast therapy session.

32. The system of claim 31, wherein the second group of one or more smart devices comprises one of a smart phone, tablet, laptop and desktop computer.

33. The system of claim 31, the one or more processors further configured to receive temperature measurements from a temperature sensor in the tub to determine when target temperatures of the contrast therapy session are achieved.

34. The system of claim 31 wherein the pumps for pumping hot and cold water to the tub from the hot and cold tempered reservoirs comprise a first set of pumps, the system further comprising a catch reservoir and a second set of pumps for pumping water from the catch reservoir back to the hot and cold tempered reservoirs, wherein the one or more processors control the second set of pumps to pump the water back to the hot and cold tempered reservoirs after completion of the contrast therapy session.

35. The system of claim 29, further comprising level sensors within the hot and cold tempered reservoirs, the one or more processors receiving closed loop feedback from the level sensors to determine when to stop the second set of pumps from pumping water back to the hot and cold tempered reservoirs.
